(19) United States
(12) Patent Application Publication
(10) Pub. No.: US 2025/0059909 A1
(43) Pub. Date: Feb. 20, 2025

(54) ARRANGEMENT OF AUXILIARY EQUIPMENT IN THE ENGINE BAY OF A COMMERCIAL VEHICLE

(71) Applicant: Daimler Truck AG, Leinfelden-Echterdingen (DE)

(72) Inventors: David REYNOLDS, Shelby, NC (US); John R. VAN HAVERBEKE, Duncan, SC (US); Scott WATSON, Boiling Spring, SC (US); Jason PARSONS, Kings Mountain, NC (US)

(21) Appl. No.: 18/711,008

(22) PCT Filed: Nov. 15, 2022
(86) PCT No.: PCT/EP2022/081996

§ 371 Date: May 16, 2024

(30) Foreign Application Priority Data
Nov. 17, 2021 (GB) 2116532.9

(51) Int. Cl. F02B 67/06; F16M 5/00

(52) U.S. Cl. CPC F02B 67/06; F16M 5/00; F02B 2275/06

(57) ABSTRACT

The invention relates to an internal combustion engine (10) comprising a cylinder block (12) comprising a plurality of cylinders. The engine (10) comprises a crankshaft (14) rotatably mounted on the cylinder block (12) about a crankshaft rotation axis (16) extending in a plane (18) which, with respect to an installation position of the internal combustion engine (10), extends in a vertical direction (20) of the vehicle. The engine (10) comprises a mounting bracket (26) separately manufactured from the cylinder block (12), the mounting bracket (26) being attached to the cylinder block (12). The engine (10) comprises a belt (30) configured to be driven by the crankshaft (14). The engine (10) comprises an alternator (34) configured to be driven by the belt (30), the alternator (34) being mounted on the mounting bracket (26). The engine (10) comprises a hydraulic steering pump (38) configured to be driven by the belt (30).

### FIELD OF THE INVENTION

The invention relates to an internal combustion engine for a vehicle, in particular a commercial vehicle.

### BACKGROUND INFORMATION

CN 2009 55647 shows an engine integral accessory bracket. Furthermore, KR 20040029736 A1 shows a bracket for mounting auxiliary equipment of an engine. Moreover, US 2002/0035980 A1 shows a multi-cylinder engine comprising a cylinder block and a cylinder head mounted on said cylinder block.

### SUMMARY OF THE INVENTION

It is an object of the present invention to provide an internal combustion engine for a vehicle such that auxiliary components may be installed in a particularly space-saving way. In an embodiment, the invention may provide packaging benefits for particular auxiliary components for the internal combustion engine. In an exemplary embodiment, the invention may enable application specific packaging for the internal combustion engine (e.g. provide advantageous packaging for alternative configurations of the internal combustion engine comprising particular auxiliary components.)

This object is solved by an internal combustion engine having the features of patent claim 1. Advantageous embodiments with expedient developments of the invention are indicated in the other patent claims.

The invention relates to an internal combustion engine for a vehicle, in particular a commercial vehicle. Thus, the internal combustion engine is configured to drive the vehicle. Preferably, the internal combustion engine is configured as a reciprocating engine. The internal combustion engine comprises a cylinder block comprising a plurality of cylinders. Preferably, the cylinders, in particular their cylinder axes, are arranged in succession along a straight line thereby, for example, forming a cylinder row. The internal combustion engine further comprises a crankshaft rotatably mounted on the cylinder block about a crankshaft rotation axis. The crankshaft is an output shaft via which the internal combustion engine may provide torques for driving the vehicle. Said crankshaft rotation axis extends in a plane which, with respect to an installation position of the internal combustion engine, extends in a vertical direction of the vehicle. The internal combustion engine assumes its installation position in a fully manufactured or assembled state of the vehicle which, in its fully manufactured or assembled state, is equipped with the internal combustion engine. With respect to the fully manufactured or assembled state of the vehicle, the transverse direction of the vehicle extends perpendicularly to a longitudinal direction of the vehicle. When the vehicle is driven forwards, in particular without performing a turning maneuver, the vehicle travels along its longitudinal direction. The vehicle further comprises a transverse direction which extends perpendicularly to both the longitudinal direction and the vertical direction of the vehicle. When the vehicle stands on a horizontal plane, the vertical direction of the vehicle extends perpendicularly to the horizontal plane.

The internal combustion engine according to the present invention further comprises a mounting bracket separately manufactured from the cylinder block. The mounting bracket is attached to the cylinder block. In an embodiment, the cylinder block and the mounting bracket are separately manufactured components which are connected with each other. The internal combustion engine further comprises at least one belt configured to be driven by the crankshaft, in particular via a crankshaft pulley. For example, the crankshaft pulley is connected with a crankshaft in a rotationally fixed manner. The internal combustion engine further comprises an alternator configured to be driven by the at least one belt. For example, the alternator is a primary alternator of the internal combustion engine. The alternator is mounted on the mounting bracket such that the alternator is mounted on the cylinder block via the mounting bracket. The internal combustion engine according to the present invention further comprises a hydraulic steering pump configured to convey a hydraulic medium for a hydraulic power steering of the vehicle. The hydraulic steering pump is configured to be driven by the at least one belt. Thus, the alternator and the hydraulic steering pump are configured to be driven by the crankshaft via the at least one belt. The hydraulic steering pump is mounted on the mounting bracket such that the hydraulic steering pump is mounted on the cylinder block via the mounting bracket.

In an exemplary embodiment, the internal combustion engine may comprise at least one refrigerating compressor configured to compress and convey a refrigerant of an air conditioning system. The air conditioning system is also referred to as an air conditioner or an air conditioning or an A/C such that the refrigerating compressor is also referred to as an A/C compressor. In another exemplary embodiment, the internal combustion engine may not comprise a refrigerating compressor. In yet another exemplary embodiment, the internal combustion may comprise one primary refrigerating compressor, and one secondary refrigerating compressor. Via the mounting bracket, the internal combustion engine may be customized to comprise a desired configuration of auxiliary components (e.g. at least one refrigerating compressor). The at least one refrigerating compressor may be configured to be driven by at the least one belt such that the at least one refrigerating compressor is configured to be driven by the crankshaft via the at least one belt. In an exemplary embodiment, the internal combustion engine may comprise two refrigerating compressors where each refrigerating compressor is driven by a belt. In an embodiment, a refrigerating compressor may be mounted on the mounting bracket such that the refrigerating compressor is mounted on the cylinder block via the mounting bracket. The auxiliary components of the internal combustion engine may comprise the alternator, the hydraulic steering pump and the at least one refrigerating compressor.

In an embodiment, particular auxiliary components (e.g. the alternator, hydraulic steering pump, and a refrigerating compressor) may be arranged on the left-hand side of the plane with respect to the installation position and forward driving direction of the vehicle.

In comparison with conventional solutions, said auxiliary components are relocated such that the internal combustion engine according to the present invention may be arranged in the vehicle in a particularly advantageous way, in particular in a small installation space. Furthermore, the internal combustion engine according to the present invention may be configured such that auxiliary components may be arranged according to customer needs.

In an embodiment, with respect to the installation position of the internal combustion engine, a belt is arranged on a front side of the cylinder block, the front side facing forwards in a longitudinal direction of the vehicle and thus in the forward driving direction of the vehicle. In an embodiment, the refrigerating compressor may be an optional component which may be omitted. In another embodiment, the internal combustion engine may comprise a single refrigerating compressor. In another embodiment, the internal combustion engine may comprise a primary and a secondary refrigerating compressor. In this regard, the internal combustion engine may comprise a primary refrigerating compressor, which may be driven by a primary belt, and a secondary refrigerating compressor which may be driven by a secondary belt. Further, the secondary refrigerating compressor may be mounted to the cylinder block of the internal combustion engine via the mounting bracket. By the invention, cost benefits may be realized, said cost benefits resulting from mounting the auxiliary components to the cylinder block via the mutual mounting bracket.

Further advantages, features, and details of the invention derive from the following description of a preferred embodiment as well as from the drawings. The features and feature combinations previously mentioned in the description as well as the features and feature combinations mentioned in the following description of the figures and/or shown in the figures alone may be employed not only in the respectively indicated combination but also in any other combination or taken alone without leaving the scope of the invention.

### BRIEF DESCRIPTION OF THE DRAWINGS

The novel features and characteristic of the disclosure are set forth in the appended claims. The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 shows a schematic front view of a first exemplary configuration of an internal combustion engine for a vehicle.

FIG. 2 shows a schematic front view of a second exemplary configuration of an internal combustion engine for a vehicle.

FIG. 3 shows a schematic front view of a third exemplary configuration of an internal combustion engine for a vehicle.

FIG. 4 shows a part of a schematic perspective view of the internal combustion engine.

FIG. 5 shows a schematic perspective view of a first mounting bracket of the internal combustion engine.

FIG. 6 shows a schematic perspective view of the second mounting bracket of the internal combustion engine.

In the figures the same elements or elements having the same function are indicated by the same reference signs.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawing and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiment of the disclosure, reference is made to the accompanying drawing that forms part hereof, and in which is shown by way of illustration a specific embodiment in which the disclosure may be practiced. This embodiment is described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

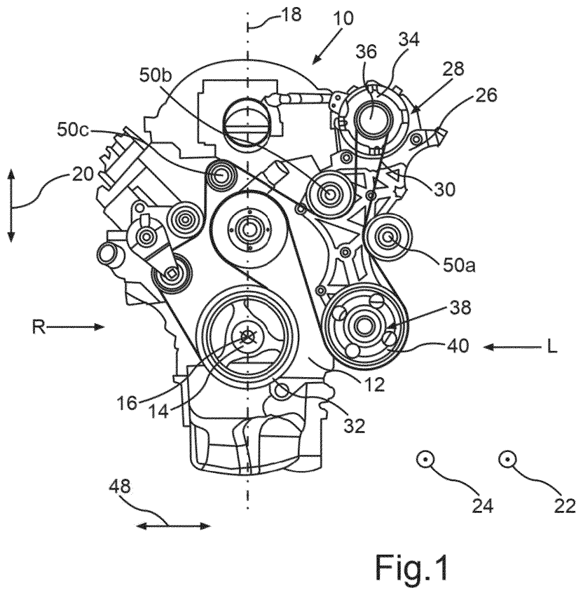

FIG. 1 shows in a schematic front view in an internal combustion engine 10 for a vehicle such as, for example, a commercial vehicle. Thus, in its fully manufactured state, the vehicle comprises the internal combustion engine 10 configured to drive the vehicle. Preferably, the vehicle is configured as a truck. Preferably, the internal combustion engine 10 is configured as a gasoline engine. The internal combustion engine 10 is also referred to as an engine. The internal combustion engine 10 comprises a cylinder block 12 comprising a plurality of cylinders. Preferably, the cylinder block 12 may comprise at least or exactly six, in particular at least or exactly eight, cylinders. For example, in each cylinder, a piston is translationally movably arranged in the respective cylinder. The internal combustion engine 10 further comprises a crankshaft 14. The pistons are articulatedly connected with the crankshaft 14 by respective connecting rods such that translational movements of the pistons in the cylinders may be converted into a rotational movement of the crankshaft 14 about a crankshaft rotation axis 16 in relation to the cylinder block 12. Thus, the crankshaft 14 is rotatably mounted on the cylinder block 12 about the crankshaft rotation axis 16. The crankshaft rotation axis 16 extends in a plane 18 which, with respect to an installation position of the internal combustion engine 10, extends in a vertical direction of the vehicle. FIG. 1 shows said installation position of the internal combustion engine 10, wherein, in FIG. 1, the vertical direction of the vehicle is illustrated by a double arrow 20. The vehicle also comprises a longitudinal direction extending perpendicularly to the vertical direction, wherein the longitudinal direction is illustrated by a double arrow 22. In FIG. 1, an arrow 24 illustrates a forward driving direction of the vehicle. The forward driving direction of the vehicle coincides or extends parallel to the longitudinal direction of the vehicle from a back to a front of the vehicle. Thus, the arrow 24 and the forward driving direction extends towards a person looking at or viewing FIG. 1. Preferably, the internal combustion engine 10 is a front engine.

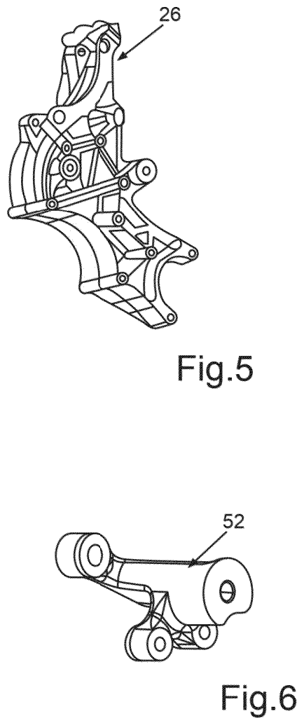

The internal combustion engine 10 further comprises a first mounting bracket 26 which is separately manufactured from the cylinder block 12. The mounting bracket 26 is attached to the cylinder block 12, in particular directly. The mounting bracket 26 is shown in FIG. 5 in a schematic perspective view. Preferably, the mounting bracket 26 is formed in one piece. This means that, preferably, the mounting bracket 26 is an integral part, i.e. an integrally formed part. In other words, the mounting bracket 26 does not comprise a plurality of separately manufactured components which are connected with each other.

Furthermore, the internal combustion engine 10 comprises a belt drive 28 comprising a belt 30. The belt 30 is configured to be driven by the crankshaft 14. For this purpose, a crankshaft pulley 32, which may be a part of the belt drive 28, is connected with the crankshaft 14, preferably in a rotatably fixed manner. The belt 30 wraps around the crankshaft pulley 32 at least partially, such that, by rotating the crankshaft 14 and thus the crankshaft pulley 32 about the rotation axis 16 in relation to the cylinder block 12, the belt 30 is driven.

The internal combustion engine 10 comprises a first auxiliary component being an alternator 34. The alternator 34 is configured to be driven by the belt 30. For this purpose, an alternator pulley 36 is connected with a shaft of the alternator 34, in particular in a rotatably fixed manner. The belt 30 wraps around the alternator pulley 36 such that, by driving the belt 30, the alternator pulley 36 and thus the alternator 34 are driven. As shown in FIG. 1, the alternator 34 is mounted on the mounting bracket 26.

The internal combustion engine 10 further comprises a second auxiliary component being a hydraulic steering pump 38 which is configured to be driven by the belt 30. For this purpose, a pump pulley 40 is connected with a shaft of the hydraulic steering pump 38, in particular in a rotationally fixed manner. Thus, by driving the belt 30, the pump pulley 40 and thus the hydraulic steering pump 38 are driven. As shown in FIG. 1, the hydraulic steering pump 38 is mounted on the mounting bracket 26.

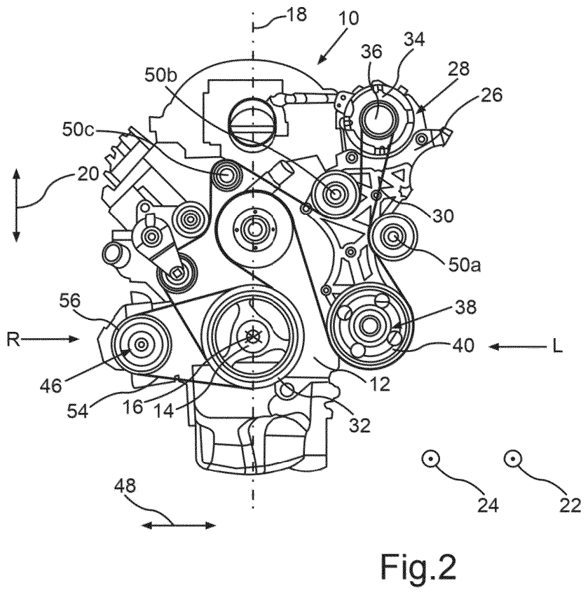

FIG. 1 shows a first exemplary embodiment of the internal combustion engine 10 wherein the internal combustion engine 10 does not comprise a refrigerating compressor. FIG. 2 shows a second exemplary embodiment of the internal combustion engine 10 wherein the internal combustion engine 10 comprises a refrigerating compressor 46, also referred to as a primary refrigerating compressor 46. The primary refrigerating compressor 46 is configured to be driven by a belt 54, also referred to as a primary belt 54. For this purpose, for example, a compressor pulley 56 is connected with a shaft of the refrigerating compressor 46, in particular in a rotationally fixed manner. Thus, by driving the belt 54, the compressor pulley 56 and thus the refrigerating compressor 46 are driven.

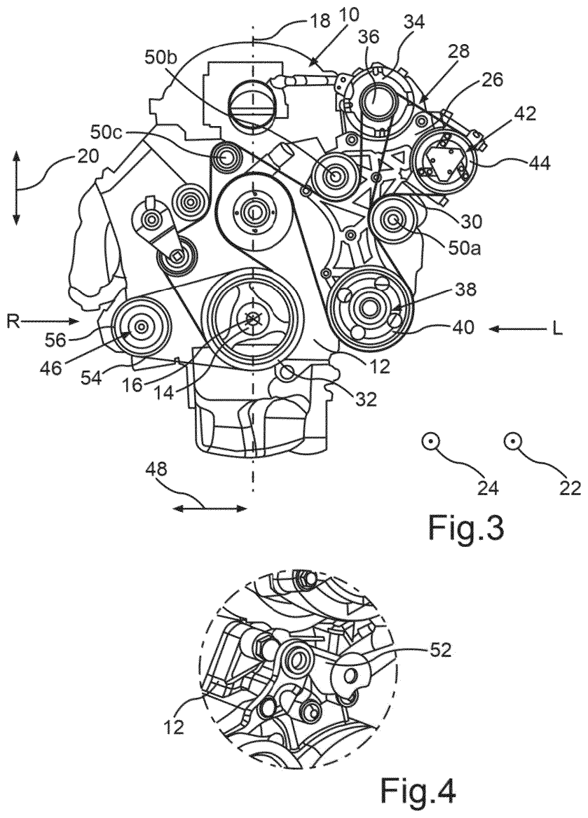

FIG. 3 shows a third exemplary embodiment of the internal combustion engine 10 wherein the internal combustion engine 10 comprises a primary refrigerating compressor 46 and a secondary refrigerating compressor 42 as an auxiliary component. The secondary refrigerating compressor 42 is configured to be driven by the belt 30, also referred to as the secondary belt 30. For this purpose, for example, a compressor pulley 44 is connected with a shaft of the refrigerating compressor 42, in particular in a rotationally fixed manner. Thus, by driving the belt 30, the compressor pulley 44 and thus the refrigerating compressor 42 are driven. As shown in FIG. 3, the refrigerating compressor 42 is mounted on the mounting bracket 26. Since the alternator 34, the hydraulic steering pump 38 and the refrigerating compressor 42 are auxiliary components which are also referred to as accessory drive components, the mounting bracket 26 is also referred to as an accessory drive mount.

The secondary refrigerating compressor 42 may be configured as an optional component which may be omitted, as depicted in FIGS. 1 and 2. In particular, the refrigerating compressor 42 may be a secondary A/C compressor which may be provided in addition to the refrigerating compressor 46, which may be a primary A/C compressor. In an embodiment, both refrigerating compressors 42 and 46 may be omitted as components of the internal combustion engine 10, as depicted in FIG. 1.

In order to arrange said auxiliary components and thus the internal combustion engine 10 in a particularly space-saving way, in particular in a small installation space of the vehicle, the alternator 34, the hydraulic steering pump 38 and the refrigerating compressor 42 are arranged on a left-hand side L of the plane 18 with respect to the installation position of the internal combustion engine 10 and the forward driving direction of the vehicle. As shown in FIG. 1, the primary refrigerating compressor 46 is arranged on a right-hand side R of the plane 18 with respect to the installation position of the internal combustion engine 10 and a forward driving direction of the vehicle, the right-hand side R being opposite of the left-hand side L in a transverse direction of the vehicle. Said transverse direction of the vehicle is illustrated by a double arrow 48, when the transverse direction of the vehicle extends perpendicularly to both, the longitudinal direction of the vehicle (double arrow 22) and the vertical direction of the vehicle (double arrow 20). Moreover, for example, the belt drive 28 is configured as a front engine accessory drive (FEAD) system configured to drive said auxiliary components. Moreover, preferably, the belt 30 is arranged on a front side of the internal combustion engine 10, in particular the cylinder block 12, wherein the front side faces in the forward travel direction (i.e. in the longitudinal direction of the vehicle towards a front of the vehicle) in a particularly easy way.

Preferably, the alternator 34 is a pad mounted alternator such that, for example, the alternator 34 is mounted on the mounting bracket 26 via a mounting pad. Alternatively or additionally, the secondary refrigerating compressor 42 may be a pad mounted compressor which may be mounted on the mounting bracket 26 via a mounting pad.

The belt drive 28 and thus the internal combustion engine 10 comprise a plurality of idler pulleys 50a-c. The respective idler pulley 50a-c is rotatable about a respective pulley rotation axis in relation to the cylinder block 12. The pulley rotation axes extend parallel to each other and are spaced away from each other. Moreover, the respective pulley rotation axis extends parallel to the crankshaft rotation axis 16 and is spaced away from the crankshaft rotation axis 16. For example, the idler pulley 50a or the idler pulley 50b is rotatably mounted on the mounting bracket 26 about the respective pulley rotation axis. For example, the internal combustion engine 10 comprises a second mounting bracket 52 shown in FIG. 6. The mounting bracket 52 is separately manufactured from both, the cylinder block 12 and the mounting bracket 26. Preferably, the mounting bracket 52 is formed in one piece. This means that, preferably, the mounting bracket 52 is an integral part (i.e. an integrally formed part). Moreover, for example, the idler pulley 50c is rotatably mounted on the second mounting bracket 52 about the pulley rotation axis of the idler pulley 50c. Thus, the idler pulleys 50a-c may be mounted in particularly advantageous way. Since, the refrigerating compressors 42 and 46 may be provided as optional components in a need-based manner, the internal combustion engine 10 may be equipped with both refrigerating compressors 42 and 46, for example, for applications that require added A/C capacity, with only the primary refrigerating compressor 46, or with neither refrigerating compressor 42 and 46.

### REFERENCE SIGNS

10 internal combustion engine
12 cylinder block
14 crankshaft
16 crankshaft rotation axis
18 plane
20 double arrow
22 double arrow
24 arrow
26 first mounting bracket
28 belt drive
30 belt
32 crankshaft pulley
34 alternator
36 alternator pulley
38 hydraulic steering pump
40 pump pulley
42 secondary refrigerating compressor
44 compressor pulley
46 primary refrigerating compressor
48 double arrow
50a-c idler pulley
52 second mounting bracket
54 belt
56 compressor pulley
L left-hand side
R right-hand side

1-7. (canceled)

8. An internal combustion engine for a vehicle, comprising:
a crankshaft rotatably mounted on a cylinder block, with a rotation axis that extends in a vertical plane that distinguishes a first side of the engine and a second side of the engine;
a first belt configured to be driven by the crankshaft;
an alternator capable to be driven via the first belt;
a pump configured to be driven by the first belt; and
a primary refrigerating compressor mounted to the cylinder block, where the primary refrigerating compressor is arranged on the first side of the engine, and the alternator and the hydraulic steering pump are arranged on the second side of the engine.

9. The engine of claim 8, further comprising a first mounting bracket separately manufactured from the cylinder block, the first mounting bracket attached to the cylinder block.

10. The engine of claim 9, wherein the alternator and the hydraulic steering pump are mounted on the first mounting bracket.

11. The engine of claim 9, further comprising:
a secondary refrigerating compressor capable to be driven via the first belt.

12. The engine of claim 11, wherein the secondary refrigerating compressor is mounted to the first mounting bracket which is in turn attached to the cylinder block.

13. The engine of claim 8, wherein the first mounting bracket is formed as a single piece.

14. The engine of claim 8, further comprising:
a second belt; and
wherein the primary refrigerating compressor is capable to be driven via the second belt.

15. The engine of claim 8, wherein the pump is a hydraulic steering pump configured to convey a hydraulic medium for a hydraulic power steering of the vehicle.

16. The engine of claim 9, further comprising:
a first idler pulley and a second idler pulley, each coupled to the first mounting bracket and configured to contact the first belt.

17. The engine of claim 9, wherein an entirety of the first mounting bracket is positioned on the second side of the engine.

18. The engine of claim 8, further comprising:
a second mounting bracket.

19. The engine of claim 18, further comprising:
a third idler pulley coupled to the second mounting bracket and configured to contact the first belt.

20. The engine of claim 19, wherein the third idler pulley is positioned on the first side of the engine.

21. The engine of claim 18, wherein the second mounting bracket is formed as a single piece.

22. An internal combustion engine for a vehicle, comprising:
a crankshaft rotatably mounted on a cylinder block, with a rotation axis that extends in a vertical plane that distinguishes a first side of the engine and a second side of the engine;
a primary refrigerating compressor arranged on the first side of the engine; and
a secondary refrigerating compressor arranged on the second side of the engine.

23. The engine of claim 22, further comprising:
a mounting bracket separately manufactured from the cylinder block, the mounting bracket attached to the cylinder block.

24. The engine of claim 23, wherein the secondary refrigerating compressor is mounted to the mounting bracket; and
wherein an entirety of the mounting bracket is positioned on the second side of the engine.

25. The engine of claim 22, further comprising:
a first belt configured to be driven by the crankshaft; and
wherein the secondary refrigerating compressor is configured to be driven by the first belt.

26. The engine of claim 22, further comprising:
a second belt configured to be driven by the crankshaft; and
wherein the primary refrigerating compressor is configured to be driven by the second belt.

27. A vehicle comprising the engine of claim 8, or the engine of claim 22.
